(19) United States
(12) Patent Application Publication
(10) Pub. No.: US 2025/0301537 A1
(43) Pub. Date: Sep. 25, 2025

(54) CERAMIC HEATER CONTROL APPARATUS, HEATING APPARATUS, AND NON-TRANSITORY COMPUTER READABLE RECORDING MEDIUM

(71) Applicant: Niterra Co., Ltd., Nagoya-shi (JP)

(72) Inventors: Kentaro SATO, Nagoya-shi (JP); Seiji MAEDA, Nagoya-shi (JP)

(21) Appl. No.: 19/081,609

(22) Filed: Mar. 17, 2025

(30) Foreign Application Priority Data
Mar. 19, 2024 (JP) 2024-043672

(51) Int. Cl. H05B 1/02; H05B 3/28

(52) U.S. Cl. CPC H05B 1/0244; H05B 3/283; H05B 1/0236; H05B 2203/02

(57) ABSTRACT

A ceramic heater control apparatus controls a ceramic heater including a resistive heating element which generates heat when energized and a ceramic base body in which the resistive heating element is embedded. The control apparatus energizes the resistive heating element, and stops the energization of the resistive heating element when the electrical resistance of the resistive heating element has exceeded an upper limit electrical resistance during the energization of the resistive heating element. The upper limit electrical resistance is obtained by adding a predetermined allowable electrical resistance to a reference electrical resistance.

### BACKGROUND

### Technical Field

The present disclosure relates to a ceramic heater control apparatus, a heating apparatus, and a non-transitory computer readable recording medium.

### Description of the Related Art

A ceramic heater having a ceramic base body including a resistive heating element embedded therein is used in a variety of applications because it is compact and lightweight, and has excellent insulating and temperature raising properties. JP2023-160310A discloses a liquid heating apparatus which heats a liquid by a ceramic heater.

In the case where a liquid is heated by a ceramic heater, the ceramic heater is heated by the heat generated by the resistive heating element, while it is cooled by the liquid. Therefore, the surface temperature of the ceramic heater gradually approaches a predetermined temperature at which the heating by the resistive heating element balances with the cooling by the liquid. The liquid flowing along the surface of the ceramic heater whose temperature gradually approaches the predetermined temperature is heated by the heat of the ceramic heater.

When the flow rate of the liquid flowing along the surface of the ceramic heater decreases or the liquid stagnates on the surface of the ceramic heater, the liquid may boil as a result of excessive heating of the liquid by the ceramic heater. When the liquid flowing along the surface of the ceramic heater boils, boiling bubbles (bubbles produced as a result of boiling) come into contact with the surface of the ceramic heater. As a result, the surface of the ceramic heater has a region where the liquid does not come into contact therewith. Since the region where the liquid does not come into contact therewith is not cooled by the liquid, its temperature increases further. When the liquid comes into contact with the region having an increased temperature as a result of, for example, moving of the boiling bubbles, since the surface is cooled rapidly by the liquid, thermal shock acts on the ceramic heater. Since the ceramic base body constituting the ceramic heater is vulnerable to thermal shock, if the thermal shock is large, cracking may occur in the ceramic heater.

### SUMMARY OF THE INVENTION

The object of the present disclosure is to solve the above-described problem. Namely, one object of the present disclosure is to provide a ceramic heater control apparatus which can prevent cracking of a ceramic heater which would otherwise occur when a liquid is heated by the ceramic heater, a heating apparatus including the control apparatus, and a non-transitory computer readable recording medium which stores a program to be executed by the ECU.

A ceramic heater control apparatus (35) according to the present disclosure controls a ceramic heater (20) including a resistive heating element (201) which generates heat when energized and a ceramic base body (202) in which the resistive heating element (201) is embedded. The control apparatus (35) energizes the resistive heating element (201) (S11) and stops the energization of the resistive heating element (201) (S24) when the electrical resistance of the resistive heating element (201) has exceeded an upper limit electrical resistance (Ru) during the energization of the resistive heating element (201) (S23: Yes). The upper limit electrical resistance (Ru) is obtained by adding a predetermined allowable electrical resistance (Rac) to a predetermined reference electrical resistance (Rref).

When cracking occurs in the ceramic heater, the electrical resistance of the resistive heating element tends to increases from the predetermined reference electrical resistance. In the case where the electrical resistance of the resistive heating element has exceeded the upper limit electrical resistance obtained by adding the predetermined allowable electrical resistance to the predetermined reference electrical resistance, the ceramic heater control apparatus according to the present disclosure determines that the possibility of occurrence of cracking in the ceramic heater is high and stops the energization of the resistive heating element. As a result, cracking of the ceramic heater can be prevented.

In one mode of the ceramic heater control apparatus according to the present disclosure, at predetermined time intervals after start of energization of the resistive heating element (201), the control apparatus (35) obtains the electrical resistance (R1) of the resistive heating element (201) (S13), determines whether or not the obtained electrical resistance (R1) of the resistive heating element (201) asymptotically changes to a predetermined value (S16), sets the reference electrical resistance (Rref) to be equal to the electrical resistance (R1) obtained upon determination that the electrical resistance (R1) of the resistive heating element (201) asymptotically changes to the predetermined value (S17), and stops the energization of the resistive heating element (201) (S24) when the electrical resistance (R2) of the resistive heating element (201) obtained after setting of the reference electrical resistance (Rref) has exceeded the upper limit electrical resistance (Ru) (S23: Yes).

When cracking occurs in the ceramic heater, the electrical resistance of the resistive heating element tends to increases after having asymptotically changed to a certain value. In the above-described configuration, the control apparatus sets the reference electrical resistance to be equal to the electrical resistance of the resistive heating element obtained upon determination that the electrical resistance asymptotically changes to the predetermined value, and compares the electrical resistance of the resistive heating element obtained thereafter with the upper limit electrical resistance. Therefore, it is possible to appropriately determine an increase of the electrical resistance of the resistive heating element after having asymptotically changed to the certain value. In addition, since the reference electrical resistance is not set to a fixed value beforehand but is set on the basis of the electrical resistance obtained when the resistive heating element is actually energized, it is possible to appropriately set the reference electrical resistance which changes depending on the individual difference and usage environment of the ceramic heater.

In another mode of the ceramic heater control apparatus according to the present disclosure, the control apparatus (35) determines (S16) whether or not an increase gradient (r) of the obtained electrical resistance of the resistive heating element (201) is less than a threshold gradient (rth) determined beforehand such that, when the electrical resistance of the resistive heating element (201) is highly likely to asymptotically change to the predetermined value, the increase gradient (r) becomes less than the threshold gradient (rth), and sets the above-described reference electrical resistance (Rref) to be equal to the electrical resistance obtained upon determination that the increase gradient (r) of the electrical resistance of the resistive heating element (201) is less than the threshold gradient (rth) (S17). The “increase gradient” of the electrical resistance means the amount of increase (the amount of rising) of the electrical resistance per unit time.

The above-described configuration enables appropriate setting of the reference electrical resistance.

In still another mode of the ceramic heater control apparatus according to the present disclosure, when a period of time (T0) set beforehand has elapsed after the electrical resistance of the resistive heating element (201) was determined to asymptotically change to the predetermined value (S20: No), the control apparatus (35) cancels a process of stopping the energization of the resistive heating element (201) upon the determination that the electrical resistance of the resistive heating element (201) exceeds the upper limit electrical resistance (Ru).

In the case where the period of time during which the resistive heating element is energized has exceeded a predetermined time, even in a normal state in which liquid is in contact with the surface of the ceramic heater (no boiling bubble is in contact with the surface), the electrical resistance of the resistive heating element may exceed the upper limit electrical resistance. In contrast, in the above-described condition, when the period of time set beforehand has elapsed after the electrical resistance of the resistive heating element was determined to asymptotically change to the predetermined value, the process of stopping the energization of the resistive heating element upon the determination that the electrical resistance of the resistive heating element exceeds the upper limit electrical resistance is cancelled. Therefore, it is possible to prevent erroneous stoppage of the energization of the resistive heating element in the above-described normal state.

In still another mode of the ceramic heater control apparatus according to the present disclosure, the allowable electrical resistance (Rac) is set beforehand as an electrical resistance determined such that, if the energization of the resistive heating element (201) is continued after the electrical resistance of the resistive heating element (201) has exceeded the upper limit electrical resistance (Ru), cracking is highly likely to occur in the ceramic heater (20).

By virtue of the above-described configuration, cracking of the ceramic heater can be prevented by stopping the energization of the resistive heating element at the point when the electrical resistance of the resistive heating element has exceeded the upper limit electrical resistance.

In still another mode of the ceramic heater control apparatus according to the present disclosure, the ceramic heater (20) is a heat exchanger for heating a liquid medium flowing through a flow passage in an apparatus mounted in a vehicle.

By virtue of the above-described configuration, even in the case where the ceramic heater is used to heat a liquid medium flowing through a flow passage in an in-vehicle apparatus, such as a refrigerant used in a vehicle air conditioner, a temperature control fluid for controlling the temperature of a vehicle battery, etc., cracking of the ceramic heater can be prevented. Thus, it is possible to expand the range of use of the ceramic heater which is vulnerable to thermal shock.

A heating apparatus (1) according to the present disclosure comprises:
a ceramic heater (20) including a resistive heating element (201) which generates heat when energized and a ceramic base body (202) in which the resistive heating element (201) is embedded; and
a ceramic heater control apparatus (35) having the above-described configuration.

By virtue of the above-described configuration, cracking of the ceramic heater included in the heating apparatus can be prevented.

A non-transitory computer readable recording medium according to the present disclosure stores a program to be executed by an ECU (351) provided in a ceramic heater control apparatus (35) which controls a ceramic heater (20) including a resistive heating element (201) which generates heat when energized and a ceramic base body (202) in which the resistive heating element (201) is embedded. The program causes the ECU (351) to perform a step (S11) of energizing the resistive heating element (201) and a step (S24) of stopping the energization of the resistive heating element (201) when the electrical resistance of the resistive heating element (201) has exceeded an upper limit electrical resistance (Ru) during the energization of the resistive heating element (201) (S23: Yes), the upper limit electrical resistance (Ru) being obtained by adding a predetermined allowable electrical resistance (Rac) to a predetermined reference electrical resistance (Rref).

By virtue of the above-described configuration, cracking of the ceramic heater can be prevented.

### BRIEF DESCRIPTION OF THE DRAWINGS

FIG. 1 is a schematic partial sectional view of a heating apparatus according to an embodiment;

FIG. 2 is a graph showing a change with time of the electrical resistance of a resistive heating element in the case where electricity was supplied to the resistive heating element when the flow rate of a liquid flowing in a case was 5 L/min;

FIG. 3 is a graph showing a change with time of the electrical resistance of the resistive heating element in the case where electricity was supplied to the resistive heating element when the flow rate of the liquid flowing in the case was 3 L/min;

FIG. 4 is a graph showing a change with time of the electrical resistance of the resistive heating element in the case where electricity was supplied to the resistive heating element when the flow rate of the liquid flowing in the case was 1 L/min;

FIG. 5 is a graph showing a change with time of the electrical resistance of the resistive heating element in the case where electricity was supplied to the resistive heating element when the flow rate of the liquid flowing in the case was 0 L/min;

FIG. 6 is a chart showing a graph representing a change with time of the electrical resistance of the resistive heating element in the case where the liquid within the case does not boil, the chart also showing the relation among a reference electrical resistance, an upper limit electrical resistance, and an allowable electrical resistance;

FIG. 7 is a chart showing a graph representing a change with time of the electrical resistance of the resistive heating element in the case where the liquid within the case boils, the chart also showing the relation among the reference electrical resistance, the upper limit electrical resistance, and the allowable electrical resistance; and

FIG. 8 is a flowchart showing one example of a program executed by an ECU to cause a control apparatus to execute cracking prevention control.

### DESCRIPTION OF THE PREFERRED EMBODIMENT

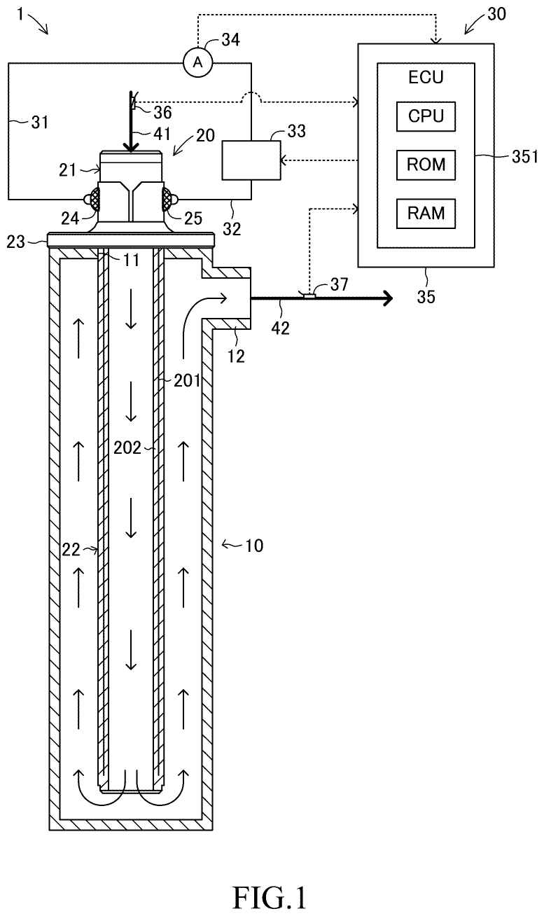

An embodiment of the present disclosure will now be described with reference to the drawings. FIG. 1 is a schematic partial sectional view of a heating apparatus 1 according to the present embodiment. As shown in FIG. 1, the heating apparatus 1 includes a case 10, a ceramic heater 20, and a control unit 30. This heating apparatus 1 is a liquid heating apparatus configured to heat a liquid to a predetermined temperature by the ceramic heater 20.

The case 10 is a member which defines a flow path of the liquid to be heated by the ceramic heater 20. The case 10 has the shape of a cylindrical tube having closed opposite ends. In FIG. 1, the case 10 is shown by a cross section including an axial line. A circular hole 11 is formed in a center portion of an upper end wall of the case 10 such that the circular hole 11 penetrates the upper end wall in an axial direction. A tubular outlet passage portion 12 is provided in a portion of a side circumferential wall of the case 10, the portion being located on the upper side of the case 10 in FIG. 1. Outlet piping 42 is connected to the outlet passage portion 12. Therefore, a space inside the case 10 communicates with a space inside the outlet piping 42 through the outlet passage portion 12. The liquid discharged from the case 10 flows through the outlet piping 42.

The ceramic heater 20 includes a resistive heating element 201 and a ceramic base body 202. The resistive heating element 201 is a member which generates heat upon energization and is formed by a long conducting wire such that it has a predetermined pattern. An example of the resistive heating element 201 is a tungsten wire. The resistive heating element 201 is embedded in the ceramic base body 202. The ceramic base body 202 is a member for heating an object to be heated and is heated by the resistive heating element 201 embedded therein. The ceramic base body 202 is formed of a ceramic material. The ceramic base body 202 is formed of, for example, alumina.

The ceramic heater 20 generally has the shape of a circular tube whose opposite ends are open. The cylindrical tubular ceramic heater 20 can be manufactured, for example, as follows. A resistive heating element formed into a predetermined pattern is sandwiched by two ceramic green sheets so as to form a laminate, and the laminate is wound around a circular tubular ceramic body. Subsequently, the ceramic body with the laminate wound therearound is fired. Thus, the circular tubular ceramic heater 20 having the ceramic base body 202 and the resistive heating element 201 embedded therein can be manufactured. The ceramic heater 20 has a base portion 21, a main body portion 22, and a flange portion 23. The base portion 21 and the main body portion 22 are juxtaposed to each other along the axial direction. The base portion 21 is formed by one end portion (an end portion on the upper side in FIG. 1) of the ceramic heater 20 having a generally circular tubular shape. Inlet piping 41 is connected to an end (an upper end in FIG. 1) of the base portion 21. The liquid to be heated by the ceramic heater 20 is introduced from the inlet piping 41 toward the internal space of the base portion 21.

The main body portion 22 is formed by a circular tubular portion other than the base portion 21. As shown in FIG. 1, the length of the main body portion 22 in the axial direction is greater than that of the base portion 21. The base portion 21 and the main body portion 22 are formed coaxially in a circular tubular shape. The spaces inside the base portion 21 and the main body portion 22 communicate with each other in the axial direction. A ring-shaped flange portion 23 is attached to the outer circumference at the position of the boundary between the base portion 21 and the main body portion 22 such that the flange portion 23 extends in the radially outward. A first electrode 24 and a second electrode 25 are provided on the outer circumferential surface of the base portion 21. Both the first electrode 24 and the second electrode 25 are formed of an electrically conductive material such as metal.

The length of the main body portion 22 in the axial direction is smaller than that of the case 10. The outer diameter of the main body portion 22 is approximately equal to the diameter of the circular hole 11 formed at the center of the upper end wall of the case 10. The main body portion 22 is inserted, from its distal end portion, into the internal space of the case 10 through the circular hole 11. As a result, the main body portion 22 is disposed in the internal space of the case 10 coaxially with the case 10. At that time, the base portion 21 is exposed upward from the upper end of the case 10, and the flange portion 23 is placed on the upper end surface of the case 10. Notably, the gap between the outer circumference of the upper end of the main body portion 22 and the wall surface of the circular hole 11 is liquid-tightly sealed by a seal member or the like.

The resistive heating element 201 of the ceramic heater 20 is embedded mainly in the ceramic base body 202 constituting the main body portion 22 in such a manner that the resistive heating element 201 forms a predetermined pattern. Opposite end portions of the resistive heating element 201 are extended to the base portion 21 and are connected to the first electrode 24 and the second electrode 25 provided on the surface of the base portion 21. Accordingly, when a predetermined voltage is applied between the first electrode 24 and the second electrode 25, electricity is supplied to the resistive heating element 201; i.e., the resistive heating element 201 is energized (current flows through the resistive heating element 201).

The control unit 30 includes a first electricity conducting member 31, a second electricity conducting member 32, a power supply apparatus 33, an ammeter 34, a control apparatus 35, an inlet temperature sensor 36, and an outlet temperature sensor 37.

Each of the first electricity conducting member 31 and the second electricity conducting member 32 is composed of a conductor having one end (first end) and the other end (second end). The first electricity conducting member 31 and the second electricity conducting member 32 are, for example, lead wires. The first end of the first electricity conducting member 31 is connected to the first electrode 24, and the first end of the second electricity conducting member 32 is connected to the second electrode 25. The second end of the first electricity conducting member 31 and the second end of the second electricity conducting member 32 are connected to the power supply apparatus 33. The power supply apparatus 33 is configured to be capable of applying the predetermined voltage between the first electricity conducting member 31 (the first electrode 24) and the second electricity conducting member 32 (the second electrode 25). The ammeter 34 is provided in the middle of the first electricity conducting member 31. The ammeter 34 measures the current flowing through the first electricity conducting member 31. The ammeter 34 may be provided in the second electricity conducting member 32.

The control apparatus 35 controls the ceramic heater 20. Specifically, the control apparatus 35 controls the state of energization of the resistive heating element 201 of the ceramic heater 20 (start of energization, stoppage of energization, and adjustment of the amount of supplied electricity) such that the temperature of the liquid heated by the ceramic heater 20 becomes equal to a predetermined target temperature. The control apparatus 35 has an ECU 351 which includes a CPU, a ROM, and a RAM. Notably, the ECU is an abbreviation for electronic control unit.

A program for controlling the state of energization of the resistive heating element 201 is previously stored in the ROM of the ECU 351. The CPU of the ECU 351 reads the program from the ROM, loads it into the RAM, and executes it. The ROM of the ECU 351 is a non-transitory computer readable storage medium.

The ammeter 34 sends a current signal representing the measured current value to the control apparatus 35. The ECU 351 of the control apparatus 35 obtains the current flowing through the first electricity conducting member 31 on the basis of the current signal received from the ammeter 34. The inlet temperature sensor 36 is attached to the inlet piping 41. The inlet temperature sensor 36 detects the temperature of the liquid flowing through the inlet piping 41 and sends a temperature signal representing the detected temperature to the control apparatus 35. The ECU 351 of the control apparatus 35 obtains the temperature of the liquid flowing through the inlet piping 41 on the basis of the temperature signal received from the inlet temperature sensor 36. The outlet temperature sensor 37 is attached to the outlet piping 42. The outlet temperature sensor 37 detects the temperature of the liquid flowing through the outlet piping 42 and sends a temperature signal representing the detected temperature to the control apparatus 35. The ECU 351 of the control apparatus 35 obtains the temperature of the liquid flowing through the outlet piping 42 on the basis of the temperature signal received from the outlet temperature sensor 37. The control apparatus 35 may receive signals other than the above-described signals. The control apparatus 35 is configured to be capable of controlling the power supply apparatus 33 on the basis of various types of input signals (current signal, temperature signals, etc.). As a result of the control of the power supply apparatus 33 by the control apparatus 35, the state of energization of the resistive heating element 201 of the ceramic heater 20 is controlled. Notably, the power supply apparatus 33 may be incorporated into the control apparatus 35.

In the present embodiment, the heating apparatus 1 having the above-described configuration heats a liquid medium flowing through a flow passage in an apparatus mounted in a vehicle. At that time, the ceramic heater 20 functions as a heat exchanger for heating the liquid medium flowing through the flow passage in the apparatus mounted in the vehicle. Examples of the apparatus mounted in the vehicle include a vehicle air conditioner, a temperature control apparatus for a vehicle battery, etc. Examples of the flow passage in the apparatus mounted in the vehicle includes a flow passage in a refrigerant circuit of the vehicle air conditioner, a flow passage formed in the temperature control apparatus for the vehicle battery, etc. In this case, the ceramic heater 20 functions as a heat exchanger for heating a refrigerant flowing through the refrigerant circuit of the vehicle air conditioner, or functions as a heat exchanger for heating a temperature controlling fluid flowing through the flow passage formed in the temperature control apparatus for the vehicle battery.

In the heating apparatus 1 having the above-described configuration, the liquid, which is an object to be heated, is introduced from the inlet piping 41 into the space inside the base portion 21 of the ceramic heater 20 and is then introduced from the base portion 21 into the internal space of the main body portion 22.

The liquid introduced into the internal space of the main body portion 22 flows downward in the main body portion 22 as indicated by arrows in FIG. 1, and flows out from the main body portion 22 through an opening at the distal end (lower end) of the main body portion 22. The liquid having flowed out from the main body portion 22 flows upward in the space between the inner wall surface of the side circumferential wall of the case 10 and the outer wall surface of the main body portion 22 as indicated by arrows in FIG. 1, and is discharged to the outlet piping 42 through the outlet passage portion 12 provided at an upper portion of the case 10. In this manner, the liquid flow passage through which the liquid supplied from the inlet piping 41 flows before being discharged to the outlet piping 42 is defined by the case 10.

When the liquid is flowing into the case 10, the control apparatus 35 controls the power supply apparatus 33 such that a predetermined voltage is applied between the first electricity conducting member 31 (the first electrode 24) and the second electricity conducting member 32 (the second electrode 25). As a result, electricity is supplied to the resistive heating element 201; i.e., the resistive heating element 201 is energized. The resistive heating element 201 generates heat when energized. The main body portion 22 is heated as a result of heat generation of the resistive heating element 201. Therefore, the liquid flowing along the surfaces (inner and outer wall surfaces) of the heated main body portion 22 is heated by the main body portion 22. In this manner, the liquid is heated by the heating apparatus 1 (the ceramic heater 20), and the heated liquid is discharged to the outlet piping 42.

The control apparatus 35 obtains, as an inlet temperature Tin, the temperature of the liquid before being heated by the heating apparatus 1, on the basis of the temperature signal sent from the inlet temperature sensor 36 attached to the inlet piping 41. In addition, the control apparatus 35 obtains, as an outlet temperature Tout, the temperature of the liquid after being heated by the heating apparatus 1, on the basis of the temperature signal sent from the outlet temperature sensor 37 attached to the outlet piping 42. The control apparatus 35 controls the power supply apparatus 33 such that the outlet temperature Tout becomes equal to a target temperature T *. Thus, the temperature of the liquid can be controlled such that the temperature of the liquid discharged to the outlet piping 42 becomes equal to a predetermined target temperature. In this case, the control apparatus 35 can control the temperature of the liquid such that the outlet temperature Tout approaches the target temperature T* by means of PI control based on the difference between the outlet temperature Tout and the target temperature T *.

In the case where the heating apparatus 1 is operating normally, the liquid introduced into the heating apparatus 1 comes into contact with the entire surfaces (inner and outer wall surfaces) of the main body portion 22 of the ceramic heater 20. Accordingly, the main body portion 22 is heated by the resistive heating element 201 and is cooled by the liquid flowing along the surfaces. Therefore, the surface temperature of the main body portion 22 increases sharply immediately after the start of energization of the resistive heating element 201. However, immediately after the sharp increase, the surface temperature asymptotically changes to a temperature at which the heating balances with the cooling, and is soon maintained at a nearly constant temperature. Thus, the liquid is heated by the main body portion 22 whose surface temperature is maintained at the nearly constant temperature.

During the operation of the heating apparatus 1, the flow rate of the liquid flowing in the case 10 may decrease or become 0, and the liquid may stagnate in the case 10. In such a case, the amount of heat applied to the liquid by the main body portion 22 may increase, causing the liquid to boil. If the liquid boils in the case 10, boiling bubbles are generated in the case 10. In the case where the generated boiling bubbles come into contact with a surface of the main body portion 22, since the liquid is not contact with a region of the surface of the main body portion 22 where the boiling bubbles are in contact with the surface, the region is not cooled by the liquid. Therefore, the temperature of the region increases further.

When the liquid again comes into contact with the region whose temperature has been increased further, as a result of, for example, moving of the boiling bubbles, that region is cooled rapidly by the liquid, whereby thermal shock acts on the main body portion 22. Since the ceramic base body 202 constituting the main body portion 22 is vulnerable to thermal shock, if the acted thermal shock is large, the ceramic heater 20 (the main body portion 22) may crack.

Accordingly, it has been demanded that the control apparatus 35 controls the energization of the resistive heating element in such a manner as to prevent cracking of the ceramic heater 20 which would otherwise occur when thermal shock acts on the ceramic heater 20 as a result of boiling of the liquid within the case 10. It is known that the electrical resistance of the resistive heating element 201 in the ceramic heater 20 increases proportionally with an increase in the temperature of the ceramic heater 20 (the main body portion 22). Accordingly, conceivably, when the temperature of the ceramic heater 20 (the main body portion 22) increases due to boiling of the liquid within the case 10, the electrical resistance of the resistive heating element 201 also increases. In view of this, the applicant investigated the way in which the electrical resistance of the resistive heating element 201 behaves when thermal shock acts on the main body portion 22 due to boiling of the liquid within the case 10.

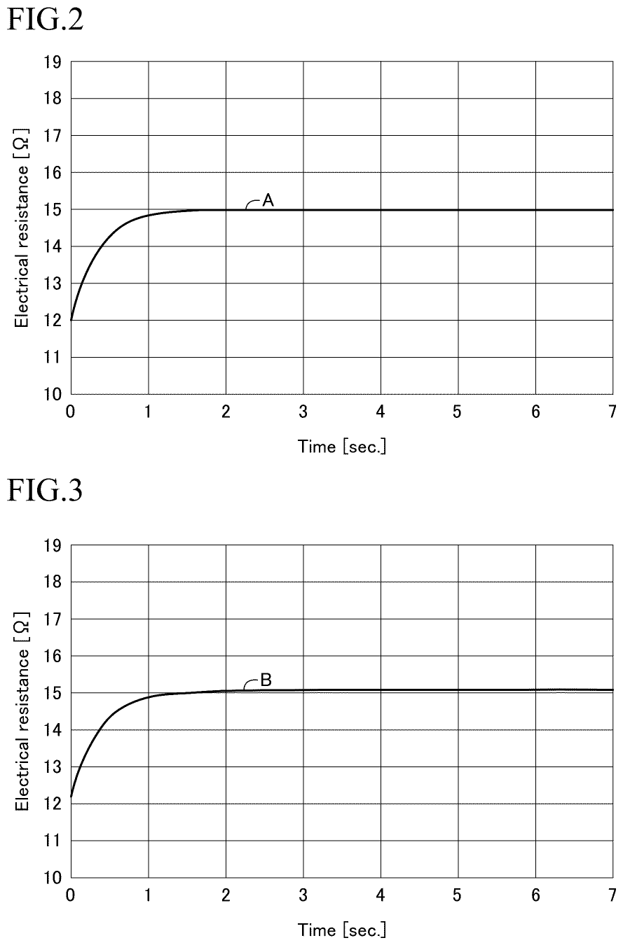

FIG. 2 is a graph showing a change with time of the electrical resistance of the resistive heating element 201 of the ceramic heater 20 in the case where the resistive heating element 201 was energized in a state in which the flow rate of the liquid flowing through the case 10 was 5 L/min. In FIG. 2, the horizontal axis represents time (sec.), and the vertical axis represents the electrical resistance (Ω) of the resistive heating element 201. As shown by graph A in FIG. 2, in the case where the flow rate of the liquid flowing through the case 10 was 5 L/min, the electrical resistance of the resistive heating element 201 sharply increased immediately after the start of energization and asymptotically changed to about 15 Ω within about 1 second from the start of energization, and the resistive heating element 201 exhibited a constant resistance of about 15 Ω thereafter. In this example case, the liquid within the case 10 did not boil, and therefore, large thermal shock did not act on the main body portion 22. Therefore, no cracking occurred in the main body portion 22. Notably, in the present specification, the expression “asymptotically changes” to a certain value means to gradually approach the certain value (15 Ω in the above-described example) and encompasses becoming equal to the certain value.

FIG. 3 is a graph showing a change with time of the electrical resistance of the resistive heating element 201 of the ceramic heater 20 in the case where the resistive heating element 201 was energized in a state in which the flow rate of the liquid flowing through the case 10 was 3 L/min. In FIG. 3 as well, the horizontal axis represents time (sec.), and the vertical axis represents the electrical resistance (Ω) of the resistive heating element 201. As shown by graph B in FIG. 3, in the case where the flow rate of the liquid flowing through the case 10 was 3 L/min, again, the electrical resistance of the resistive heating element 201 sharply increased immediately after the start of energization and asymptotically changed to about 15 Ω within about 1 second from the start of energization, and the resistive heating element 201 exhibited a constant resistance of about 15 Ω thereafter. In this example case as well, the liquid within the case 10 did not boil, and therefore, large thermal shock did not act on the main body portion 22. Therefore, no cracking occurred in the main body portion 22.

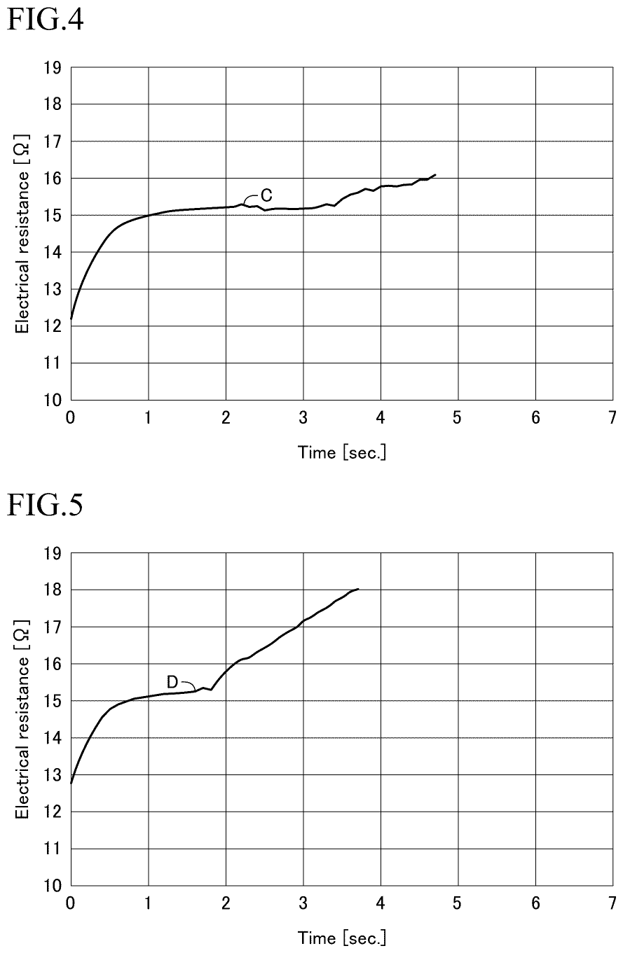

FIG. 4 is a graph showing a change with time of the electrical resistance of the resistive heating element 201 of the ceramic heater 20 in the case where the resistive heating element 201 was energized in a state in which the flow rate of the liquid flowing through the case 10 was 1 L/min. In FIG. 4 as well, the horizontal axis represents time (sec.), and the vertical axis represents the electrical resistance (Ω) of the resistive heating element 201. As shown by graph C in FIG. 4, in the case where the flow rate of the liquid flowing through the case 10 was 1 L/min, again, the electrical resistance of the resistive heating element 201 sharply increased immediately after the start of energization and asymptotically changed to about 15 Ω within about 1 second from the start of energization. Although the resistive heating element 201 thereafter maintained the electrical resistance of about 15 Ω for a while, after elapse of about 3.5 second from the start of energization, the electrical resistance started to increase and reached 16 Ω when about 4.5 sec elapsed from the start of energization. In this example case, the liquid within the case 10 boiled. Since boiling bubbles produced due to boiling are swept away by the liquid, the boiling bubbles move while being in contact with the surface of the main body portion 22. As a result, thermal shock acts on the main body portion 22. Notably, at the beginning of boiling, the amount of boiling bubbles produced is small, and therefore, the amount of increase in the temperature of the main body portion 22 is small. Therefore, even if the boiling bubbles move on the surface of the main body portion 22, the thermal shock acting on the main body portion 22 is small, and no cracking occurs in the main body portion 22. However, since the amount of boiling bubbles produced increases as time elapses after start of boiling, the surface temperature of the main body portion 22 increases greatly. Therefore, the thermal shock acting on the main body portion 22 gradually increased, and cracking occurred in the main body portion 22 when the electrical resistance reached 16 Ω (after elapse of about 4.5 seconds from the start of energization).

FIG. 5 is a graph showing a change with time of the electrical resistance of the resistive heating element 201 of the ceramic heater 20 in the case where the resistive heating element 201 was energized in a state in which the flow rate of the liquid flowing through the case 10 was 0 L/min; i.e., the liquid stagnated in the case 10. In FIG. 5 as well, the horizontal axis represents time (sec.), and the vertical axis represents the electrical resistance (Ω) of the resistive heating element 201. As shown by graph D in FIG. 5, in the case where the liquid stagnated in the case 10, again, the electrical resistance of the resistive heating element 201 sharply increased immediately after the start of energization and asymptotically changed to about 15 Ω within about 1 second from the start of energization. The resistive heating element 201 thereafter maintained the electrical resistance of about 15 Ω for a while although a slight increase was observed. However, after elapse of about 2 second from the start of energization, the electrical resistance started to increase greatly and reached 18 Ω when about 3.8 second elapsed from the start of energization. In this example case, the liquid within the case 10 boiled. However, since the flow rate of the liquid is zero, boiling bubbles are not swept away by the liquid, and stay at the same positions. Accordingly, although the temperature of a region of the surface of the main body portion 22 in contact with the boiling bubbles increases greatly, large thermal shock does not act on that region. Therefore, cracking does not occur. At the point when the electrical resistance reached 18 Ω, the heating apparatus 1 is determined to be in failure, and energization of the resistive heating element 201 was stopped, whereby boiling of the liquid ended. Since the boiling bubbles disappeared as a result of ending of boiling, the liquid came into contact with the region of the surface of the main body portion 22, which region had been in contact with boiling bubbles until then, whereby large thermal shock acted on that region. As a result, cracking occurred in the main body portion 22.

The above reveals the following. Irrespective of whether the liquid within the case 10 boils or does not boil, after sharply increasing immediately after the start of energization, the electrical resistance of the resistive heating element 201 asymptotically changes to a predetermined electrical resistance once. Also, in the case where the liquid within the case 10 does not boil, the electrical resistance of the resistive heating element 201 is approximately maintained after asymptotically changing to the predetermined electrical resistance. In contrast, in the case where the liquid within the case 10 boils, the electrical resistance of the resistive heating element 201 starts to increase again after elapse of a relatively short period of time (one to three seconds) after asymptotically changing to the predetermined electrical resistance. Conceivably, such re-increase of the electrical resistance occurs because, as a result of boiling of the liquid within the case 10, boiling bubbles come into contact with a region of the surface of the main body portion 22, and thus, the temperature of that region increases.

Accordingly, determination as to whether or not the liquid within the case 10 is boiling can be made by detecting the re-increase of the electrical resistance of the resistive heating element 201, and cracking of the main body portion 22 due to boiling of the liquid can be prevented by quickly stopping the energization of the resistive heating element 201 upon determination that the liquid within the case 10 is boiling.

In this case, it is necessary to determine whether the increase of the electrical resistance of the resistive heating element 201 is the first sharp increase immediately after the start of energization or the re-increase. As can be understood from FIGS. 4 and 5, the re-increase of the electrical resistance of the resistive heating element 201 occurs after the electrical resistance of the resistive heating element 201 has asymptotically changed to the predetermined electrical resistance. Accordingly, when the electrical resistance increases after having asymptotically changed to the predetermined electrical resistance, that increase can be determined as a re-increase.

The determination as to whether or not the electrical resistance of the resistive heating element 201 has asymptotically changed to the predetermined electrical resistance can be made on the basis of the increase gradient r of the electrical resistance (the amount of increase of the electrical resistance per unit time). Specifically, in the case where the increase gradient r of the electrical resistance is smaller than a predetermined threshold gradient rth, it is possible to determine that the electrical resistance has asymptotically changed to the predetermined electrical resistance. The threshold gradient rth is determined beforehand such that, if the increase gradient r of the electrical resistance of the resistive heating element 201 is less than the threshold gradient rth, the electrical resistance is highly likely to asymptotically change to the predetermined electrical resistance. As shown in FIGS. 2 to 5, the increase gradient r of the electrical resistance of the resistive heating element 201 is about 3 to 5 Ω/sec. at the point in time when the electrical resistance of the resistive heating element 201 sharply increases immediately after the start of energization of the resistive heating element 201, and the increase gradient r decreases with time. Accordingly, the threshold gradient rth can be set to a value equal to or less than the increase gradient at a point near the point when the sharp increase of the electrical resistance has ended; for example, can be set to a value equal to or less than 1.0 Ω/sec.

As shown in FIG. 5, during the period between the sharp increase of the electrical resistance and the re-increase of the electrical resistance, the electrical resistance may increase gradually in some cases. Accordingly, in the case where the threshold gradient rth is excessively small, there arises the possibility that, despite the electrical resistance being asymptotically changing to the predetermined electrical resistance, the increase gradient of the electrical resistance is not determined to be less than the threshold gradient, and thus, the re-increase of the electrical resistance is not detected. Accordingly, the threshold gradient rth should not be too small. For example, the threshold gradient rth is set to a value equal to or greater than 0.5 Ω/sec.

For the above reason, a value within the range of 0.5 Ω/sec. to 1.0 Ω/sec. can be employed as the threshold gradient rth. For example, the threshold gradient rth is set to 0.5 Ω/sec.

The determination as to whether or not the electrical resistance of the resistive heating element 201 has increased again can be made by determining whether or not the electrical resistance has exceeded an electrical resistance obtained by adding a predetermined electrical resistance to the electrical resistance at the time when the electrical resistance is determined to have asymptotically changed to the predetermined electrical resistance. Notably, in the following description, the electrical resistance of the resistive heating element 201 at the time when the electrical resistance is determined to have asymptotically changed to the predetermined electrical resistance may be referred to as a reference electrical resistance Rref, the predetermined electrical resistance added to the reference electrical resistance Rref may be referred to as an allowable electrical resistance Rac, and the electrical resistance obtained by adding the allowable electrical resistance Rac to the reference electrical resistance Rref may be referred to as an upper limit electrical resistance Ru. Accordingly, the determination as to whether or not the electrical resistance of the resistive heating element 201 has increased again can be made by determining whether or not the electrical resistance of the resistive heating element 201 has exceeded the upper limit electrical resistance Ru, which is obtained by adding the allowable electrical resistance Rac to the reference electrical resistance Rref. Cracking of the ceramic heater 20 can be prevented by stopping the energization of the resistive heating element 201 at the time when the electrical resistance of the resistive heating element 201 has exceeded the upper limit electrical resistance Ru.

The reference electrical resistance Rref is set to the electrical resistance which is obtained when the increase gradient r of the electrical resistance becomes less than the threshold gradient rth.

The allowable electrical resistance Rac is set beforehand in accordance with the temperature characteristic of each ceramic heater 20. In the case where the allowable electrical resistance Rac is excessively large, the main body portion 22 may crack before detection of the re-increase of the electrical resistance. Accordingly, the allowable electrical resistance Rac is preferably set beforehand such that, at the point in time when the electrical resistance of the resistive heating element 201 has exceeded the upper limit electrical resistance Ru (=Rref+Rac), cracking has not yet occurred in the ceramic heater 20 because the magnitude of thermal shock acting on the ceramic heater 20 is still small, and, in the case where energization of the resistive heating element 201 still continues after the electrical resistance of the resistive heating element 201 has exceeded the upper limit electrical resistance Ru, the magnitude of the thermal shock increases and the ceramic heater 20 is highly likely to crack. Such an allowable electrical resistance Rac can be obtained by, for example, performing an experiment. However, in the case where the allowable electrical resistance Rac is excessively small, there arises the possibility that an erroneous determination that the electrical resistance has increased again is made despite the fact that the electrical resistance has not increased again. Accordingly, the allowable electrical resistance Rac is preferably as small as possible but large enough so that the above-described erroneous determination is not made. For example, the allowable electrical resistance Rac is set to 0.5 Ω.

As can be understood from FIGS. 4 and 5, the re-increase of the electrical resistance of the resistive heating element 201 occurs within several seconds after the electrical resistance of the resistive heating element 201 is determined to have asymptotically changed to the predetermined electrical resistance. Accordingly, the re-increase of the electrical resistance of the resistive heating element 201 can be detected by monitoring the electrical resistance of the resistive heating element 201 only for a predetermined time (for example, 10 seconds) from the point in time when the increase gradient r of the electrical resistance has been determined to be less than the threshold gradient rth. Furthermore, when, for example, several minutes or more has elapsed after the start of energization of the resistive heating element 201, the temperature of the liquid within the case 10 itself increases. Thus, the surface temperature of the main body portion 22 also increases, and the electrical resistance of the resistive heating element 201 also increases. Therefore, there arises the possibility that, after elapse of several minutes after the start of energization of the resistive heating element 201, the electrical resistance of the resistive heating element 201 exceeds the upper limit electrical resistance Ru despite the fact that the liquid within the case 10 does not boil. Accordingly, the above-described monitoring of the electrical resistance of the resistive heating element 201 is preferably performed for a predetermined period of time from the point in time when the increase gradient r of the electrical resistance has been determined to be less than the threshold gradient rth. In the case where the electrical resistance of the resistive heating element 201 does not exceed the upper limit electrical resistance Ru despite elapse of the predetermined period of time, it is possible to determine that the heating apparatus 1 is operating normally and cancel the process of stopping the energization of the resistive heating element 201, which process is performed upon determination that the electrical resistance of the resistive heating element 201 has exceeded the upper limit electrical resistance Ru.

In view of the above consideration, the control apparatus 35 executes control (cracking prevention control) for preventing cracking of the ceramic heater 20 as follows. The control apparatus 35 computes (obtains) the electrical resistance of the resistive heating element 201 at predetermined time intervals, and determines whether or not the increase gradient r of the computed electrical resistance of the resistive heating element 201 is less than the threshold gradient rth. The control apparatus 35 then sets the reference electrical resistance Rref to be equal to the electrical resistance computed when the control apparatus 35 has determined that the increase gradient r is less than the threshold gradient rth. Subsequently, the control apparatus 35 determines whether or not the electrical resistance of the resistive heating element 201 obtained after the reference electrical resistance Rref has been set is greater than the upper limit electrical resistance Ru obtained by adding the allowable electrical resistance Rac to the reference electrical resistance Rref. In the case where the electrical resistance of the resistive heating element 201 is greater than the upper limit electrical resistance Ru, the control apparatus 35 determines that the electrical resistance of the resistive heating element 201 has increased again. In the case where the control apparatus 35 determines that the electrical resistance of the resistive heating element 201 has increased again, the control apparatus 35 stops energization of the resistive heating element 201, thereby preventing cracking of the main body portion 22. In addition, in the case where the electrical resistance of the resistive heating element 201 does not exceed the upper limit electrical resistance Ru even when the predetermined period of time has elapsed from the point in time when the control apparatus 35 determined that the increase gradient r is less than the threshold gradient rth, the control apparatus 35 cancels the process of stopping the energization of the resistive heating element 201, which process is performed upon determination that the electrical resistance of the resistive heating element 201 has exceeded the upper limit electrical resistance Ru. By virtue of this, it is possible to prevent erroneous stoppage of energization of the resistive heating element 201 in the case where the heating apparatus 1 is operating normally (the case where boiling bubbles are not produced in the case 10).

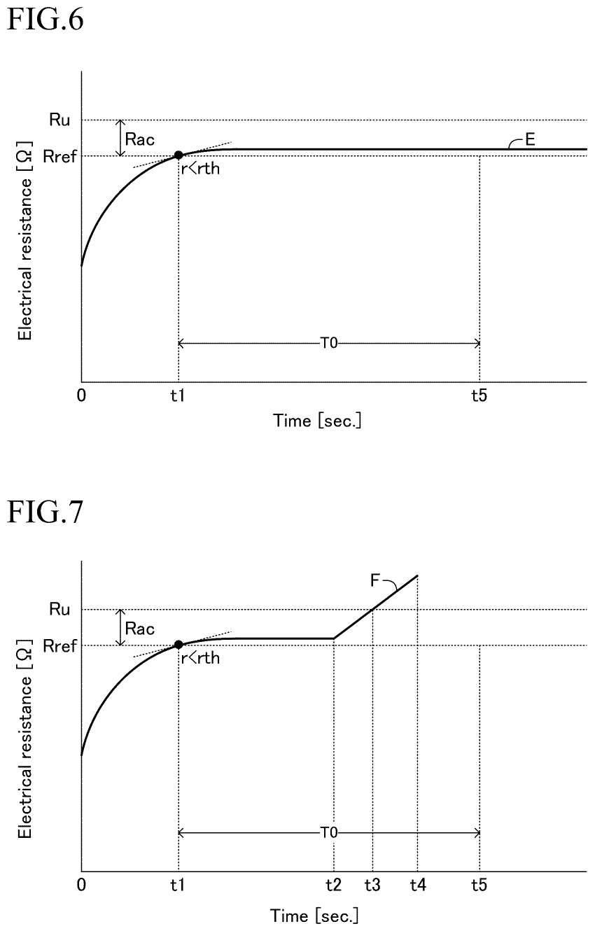

FIG. 6 is a chart which shows a graph (graph E) showing a change with time in the electrical resistance of the resistive heating element 201 in the case where the liquid within the case 10 does not boil and also shows the relation amount the reference electrical resistance Rref, the upper limit electrical resistance Ru, and the allowable electrical resistance Rac. In FIG. 6, the horizontal axis represents elapsed time (sec.), and the vertical axis represents the electrical resistance of the resistive heating element 201 (Ω). As shown in the graph E of FIG. 6, when energization of the resistive heating element 201 is started (t=0), the electrical resistance of the resistive heating element 201 sharply increases immediately after the start of energization and then asymptotically changes to a predetermined value. Therefore, the increase gradient r of the electrical resistance gradually becomes smaller. The increase gradient r becomes less than the threshold gradient rth at time t1. At that time, the control apparatus 35 sets the reference electrical resistance Rref to be equal to the electrical resistance obtained when the increase gradient r has become less than the threshold gradient rth.

After time t1, the control apparatus 35 determines whether or not the electrical resistance of the resistive heating element 201 is greater than the upper limit electrical resistance Ru (=Rref+Rac) obtained by adding the allowable electrical resistance Rac to the reference electrical resistance Rref. In this example, since the liquid within the case 10 does not boil and the temperature of the main body portion 22 is maintained constant, the resistive heating element 201 maintains a predetermined electrical resistance close to the reference electrical resistance Rref. Therefore, the electrical resistance of the resistive heating element 201 never exceeds the upper limit electrical resistance. Since the electrical resistance of the resistive heating element 201 is not greater than the upper limit electrical resistance at time t5 after elapse of a set time T0 from time t1, the control apparatus 35 ends the process of stopping the energization of the resistive heating element 201, which process is performed upon determination that the electrical resistance of the resistive heating element 201 has exceeded the upper limit electrical resistance Ru. Namely, the control apparatus 35 stops the monitoring of the electrical resistance of the resistive heating element 201. Accordingly, the energization of the resistive heating element 201 is continued after that, and the liquid is heated to a desired temperature by the heating apparatus 1.

FIG. 7 is a chart which shows a graph (graph F) showing a change with time in the electrical resistance of the resistive heating element 201 in the case where the liquid within the case 10 boils and also shows the relation amount the reference electrical resistance Rref, the upper limit electrical resistance Ru, and the allowable electrical resistance Rac. In FIG. 7, the horizontal axis represents elapsed time (sec.), and the vertical axis represents the electrical resistance of the resistive heating element 201 (Ω). As shown in the graph F of FIG. 7, when energization of the resistive heating element 201 is started (t=0), the electrical resistance of the resistive heating element 201 sharply increases immediately after the start of energization and then asymptotically changes to a predetermined value. Therefore, the increase gradient r of the electrical resistance gradually becomes smaller. The increase gradient r becomes less than the threshold gradient rth at time t1. At that time, the control apparatus 35 sets the reference electrical resistance Rref to be equal to the electrical resistance obtained when the increase gradient r has become less than the threshold gradient rth.

After time t1, the control apparatus 35 determines whether or not the electrical resistance of the resistive heating element 201 is greater than the upper limit electrical resistance Ru (=Rref+Rac) obtained by adding the allowable electrical resistance Rac to the reference electrical resistance Rref. In this example, since the liquid within the case 10 boils, the electrical resistance of the resistive heating element 201 is maintained at an approximately constant value for a while after time t1. However, the electrical resistance of the resistive heating element 201 starts to increase at time t2 (>t1). The electrical resistance of the resistive heating element 201 then exceeds the upper limit electrical resistance Ru at time t3 (>t2). Therefore, the control apparatus 35 stops the energization of the resistive heating element 201. Notably, if the energization is not stopped, cracking occurs in the main body portion 22 at time t4 (>t3). Accordingly, it is possible to prevent cracking of the ceramic heater 20 by stopping the energization of the resistive heating element 201 at time t3.

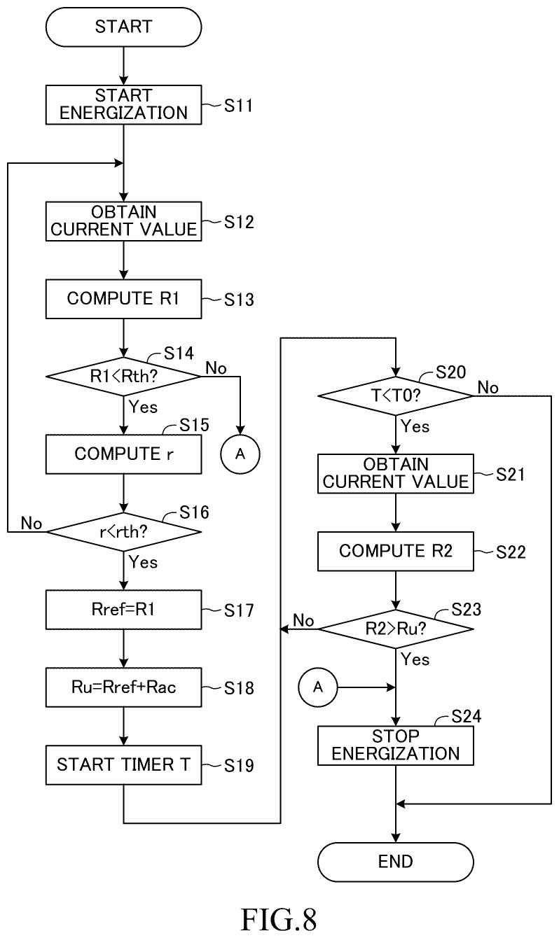

FIG. 8 is a flowchart showing one example of a program executed by the ECU 351 of the control apparatus 35 to cause the control apparatus 35 to execute the cracking prevention control described above.

When execution of the program shown in FIG. 8 is started, the ECU 351 first starts energization of the resistive heating element 201 in step 11 of FIG. 8 (in the following description, step is abbreviated as S). Notably, when energization of the resistive heating element 201 is started, the ECU 351 executes temperature control (for example, PI control) so as to control the temperature of the liquid heated by the heating apparatus 1. A program for executing this temperature control will not be described herein.

Next, the ECU 351 obtains a current value from the ammeter 34 (S12). Subsequently, the ECU 351 computes the electrical resistance R1 of the resistive heating element 201 (S13). The electrical resistance R1 can be computed on the basis of the voltage applied between the first electricity conducting member 31 and the second electricity conducting member 32 and the current value obtained in S12.

Subsequently, the ECU 351 determines whether or not the electrical resistance R1 computed in S13 is less than a predetermined abnormal value Rth (S14). The abnormal value Rth is set to a value large enough to determine that the heating apparatus 1 has failed. The abnormal value Rth is set to a value larger than the upper limit electrical resistance Ru. In the case where the electrical resistance R1 is equal to or greater than the abnormal value Rth (S14: No), the processing proceeds to S24 so as to stop the energization of the resistive heating element 201 by the power supply apparatus 33. The ECU 351 then ends the execution of this program. Meanwhile, in the case where the electrical resistance R1 is less than the abnormal value Rth (S14: Yes), the processing proceeds to S15.

In S15, the ECU 351 computes the increase gradient r of the electrical resistance of the resistive heating element 201. The increase gradient r is the amount of increase of the electrical resistance per unit time. In this case, the ECU 351 stores the electrical resistance R0 computed in S13 at the point in time which is a predetermined short amount time earlier than the present point in time (hereinafter the electrical resistance RO will be referred to as the “previously computed electrical resistance R0”). Therefore, the ECU 351 can compute the difference (R1−R0) between the electrical resistance R1 computed at the present point in time and the previously computed electrical resistance R0, convert the difference to a difference per second, and use the difference per second as the increase gradient r.

Next, the ECU 351 determines whether or not the computed increase gradient r is less than the threshold gradient rth (S16). The predetermined threshold gradient rth is set to, for example, 0.5 Ω/sec. However, the predetermined threshold gradient rth is not limited thereto. In the case where the increase gradient r is equal to or greater than the threshold gradient rth (S16: No), the processing returns to S12. Therefore, the processing of S12 to S15 is repeated until the increase gradient r becomes less than the threshold gradient rth. As a result, every time the predetermined short amount time elapses, the electrical resistance R1 of the resistive heating element 201 is computed (obtained), and the determination as to whether or not the increase gradient r is less than the threshold gradient is made. Meanwhile, in the case where the increase gradient r is less than the threshold gradient rth (S16: Yes), the processing proceeds to S17.

In S17, the ECU 351 sets the reference electrical resistance Rref to be equal to the electrical resistance R1 computed in S13 when the result of the determination in S16 is “Yes.” As a result, the electrical resistance R1 obtained when the increase gradient r has been determined to be less than the threshold gradient rth for the first time is stored as the reference electrical resistance Rref. Subsequently, the ECU 351 computes the upper limit electrical resistance Ru by adding the allowable electrical resistance Rac to the reference electrical resistance Rref (S18). The allowable electrical resistance Rac is set beforehand. The allowable electrical resistance Rac is set to, for example, 0.5 Ω. However, the allowable electrical resistance Rac is not limited thereto.

Next, the ECU 351 starts time measurement by using a timer (S19). Subsequently, the ECU 351 determines whether or not the elapsed time T measured by the timer is less than a set time T0 (S20). The set time T0 is appropriately determined in accordance with the specifications of the heating apparatus 1, the length of the resistive heating element 201, etc. The set time T0 is set to, for example, 10 seconds. However, the set time T0 is not limited thereto. In the case where the elapsed time T measured by the timer is less than the set time T0 (S20: Yes), the processing proceeds to S21.

In S21, the ECU 351 obtains the current value at the present point in time on the basis of the current signal sent from the ammeter 34. Subsequently, the ECU 351 computes the electrical resistance R2 of the resistive heating element 201 on the basis of the voltage applied between the first electricity conducting member 31 and the second electricity conducting member 32 and the current value obtained in S21 (S22). Notably, the electrical resistance of the resistive heating element 201 computed before setting of the reference electrical resistance Rref is referred to as the electrical resistance R1, and the electrical resistance of the resistive heating element 201 computed after setting of the reference electrical resistance Rref is referred to as the electrical resistance R2.

Subsequently, the ECU 351 determines whether or not the electrical resistance R2 computed in S22 is greater than the upper limit electrical resistance Ru (S23). In the case where the electrical resistance R2 is equal to or less than the upper limit electrical resistance Ru (S23: No), the processing returns to S20. As a result, during the period in which the elapsed time T measured by the timer is less than the set time T0, every time the predetermined short amount time elapses, the electrical resistance R2 of the resistive heating element 201 is computed (obtained), and the determination as to whether or not the computed electrical resistance R2 is greater than the upper limit electrical resistance Ru is made. In the case where the electrical resistance R2 is greater than the upper limit electrical resistance Ru (S23: Yes), the processing proceeds to S24.

In the case where the electrical resistance R2 is greater than the upper limit electrical resistance Ru (S23: Yes), the ECU 351 determines that the electrical resistance of the resistive heating element 201 is increasing again. In this case, the ECU 351 determines that, if energization of the resistive heating element 201 is continued, the main body portion 22 is highly likely to crack. Accordingly, in S24, the ECU 351 controls the power supply apparatus 33 to stop the energization of the resistive heating element 201. As a result, the energization of the resistive heating element 201 is stopped. After that, the ECU 351 ends the execution of this program. Notably, in the case where the energization of the resistive heating element 201 is stopped by the processing of S24, the execution of the temperature control for the liquid heated by the heating apparatus 1 is also stopped.

In the case where the elapsed time T measured by the timer is determined to be equal to or greater than the set time T0 (S20: No), the ECU 351 determines that the re-increase of the electrical resistance of the resistive heating element 201 does not occur; namely, determines that cracking of the main body portion 22 due to boiling of the liquid within the case 10 does not occur, and the ECU 351 ends the execution of this program. As a result, the energization stopping process by S24 is cancelled. Notably, in this case, the execution of the temperature control (for example, PI control) for the liquid heated by the heating apparatus 1 is continued.

As a result of execution of the above-described program by the ECU 351, the control apparatus 35 can detect the re-increase of the electrical resistance of the resistive heating element 201 (S23). The control apparatus 35 quickly stops the energization of the resistive heating element 201 (S24) when the re-increase of the electrical resistance of the resistive heating element 201 is detected. Therefore, it is possible to prevent cracking of the main body portion 22 due to boiling of the liquid within the case 10.

In addition, every time the resistive heating element 201 is energized, the ECU 351 executes the above-described program, whereby the control apparatus 35 executes the cracking prevention control. Therefore, it is possible to appropriately set the reference electrical resistance Rref in accordance with the environment in which the ceramic heater 20 is used and changes over time. Accordingly, it is possible to effectively prevent cracking of the ceramic heater 20 (the main body portion 22) without being affected by disturbances such as the use environment and changes over time.

Although the embodiment of the present disclosure has been described, the technique according to the present disclosure is not limited to the above-described embodiment. For example, in the above-described embodiment, the ECU 351 determines, in S23 of FIG. 8, whether or not the electrical resistance R2 of the resistive heating element 201 is greater than the upper limit electrical resistance Ru obtained by adding the allowable electrical resistance Rac to the reference electrical resistance Rref. However, the ECU 351 may determine whether or not the difference between the electrical resistance R2 and the reference electrical resistance Rref is greater than the allowable electrical resistance Rac. In addition, the numerical values shown in the above-described embodiments are mere examples and may be appropriately set in accordance with the specifications of the ceramic heater 20, etc. Also, for example, in the case where the ratio (duty ratio) of electric power output from the power supply apparatus 33 to the resistive heating element 201 can be adjusted, the control apparatus 35 may be configured such that the cracking prevention control executed by the control apparatus 35 is not executed when the duty ratio is low. This is because, in the case where the reference electrical resistance is set when the duty ratio is low and then the duty ratio is increased, even when no cracking has occurred in the ceramic heater 20, the electrical resistance of the resistive heating element 201 is likely to exceed the upper limit electrical resistance Ru. Accordingly, the control apparatus 35 may be configured to execute the cracking prevention control when the duty ratio is 80% or greater. As described above, the technique according to the present disclosure can be modified without departing from the scope thereof.

Furthermore, the present disclosure encompasses the following modes.

[1] A ceramic heater control apparatus for controlling a ceramic heater including a resistive heating element which generates heat when energized and a ceramic base body in which the resistive heating element is embedded, wherein the control apparatus energizes the resistive heating element, and stops the energization of the resistive heating element when the electrical resistance of the resistive heating element has exceeded an upper limit electrical resistance during the energization of the resistive heating element, the upper limit electrical resistance being obtained by adding a predetermined allowable electrical resistance to a predetermined reference electrical resistance.
[2] A ceramic heater control apparatus described in the above paragraph [1], wherein, at predetermined time intervals after start of energization of the resistive heating element, the control apparatus obtains the electrical resistance of the resistive heating element, determines whether or not the obtained electrical resistance of the resistive heating element asymptotically changes to a predetermined value, sets the reference electrical resistance to be equal to the electrical resistance obtained upon determination that the electrical resistance of the resistive heating element asymptotically changes to the predetermined value, and stops the energization of the resistive heating element when the electrical resistance of the resistive heating element obtained after setting of the reference electrical resistance has exceeded the upper limit electrical resistance.
[3] A ceramic heater control apparatus described in the above paragraph [2], wherein the control apparatus determines whether or not an increase gradient of the obtained electrical resistance of the resistive heating element is less than a threshold gradient determined beforehand such that, when the electrical resistance of the resistive heating element is highly likely to asymptotically change to the predetermined value, the increase gradient becomes less than the threshold gradient, and sets the reference electrical resistance to be equal to the electrical resistance obtained upon determination that the increase gradient of the electrical resistance of the resistive heating element is less than the threshold gradient.
[4] A ceramic heater control apparatus described in the above paragraph [2] or [3], wherein, when a period of time set beforehand has elapsed after the electrical resistance of the resistive heating element was determined to asymptotically change to the predetermined value, the control apparatus cancels a process of stopping the energization of the resistive heating element upon the determination that the electrical resistance of the resistive heating element exceeds the upper limit electrical resistance.
[5] A ceramic heater control apparatus described in any of the above paragraphs [1] to [4], wherein the allowable electrical resistance is set beforehand as an electrical resistance determined such that, if the energization of the resistive heating element is continued after the electrical resistance of the resistive heating element has exceeded the upper limit electrical resistance, cracking is highly likely to occur in the ceramic heater.
[6] A ceramic heater control apparatus described in any of the above paragraphs [1] to [5], wherein the ceramic heater is a heat exchanger for heating a liquid medium flowing through a flow passage in an apparatus mounted in a vehicle.
[7] A heating apparatus comprising:
a ceramic heater including a resistive heating element which generates heat when energized and a ceramic base body in which the resistive heating element is embedded; and
a ceramic heater control apparatus described in any of the above paragraphs [1] to [6].
   [8] A non-transitory computer readable recording medium which stores a program to be executed by an ECU provided in a ceramic heater control apparatus which controls a ceramic heater including a resistive heating element which generates heat when energized and a ceramic base body in which the resistive heating element is embedded, the program causing the ECU to perform a step of energizing the resistive heating element and a step of stopping the energization of the resistive heating element when the electrical resistance of the resistive heating element has exceeded an upper limit electrical resistance during the energization of the resistive heating element, the upper limit electrical resistance being obtained by adding a predetermined allowable electrical resistance to a predetermined reference electrical resistance.

What is claimed is:

1. A ceramic heater control apparatus for controlling a ceramic heater including a resistive heating element which generates heat when energized and a ceramic base body in which the resistive heating element is embedded, wherein
the control apparatus energizes the resistive heating element, and stops the energization of the resistive heating element when the electrical resistance of the resistive heating element has exceeded an upper limit electrical resistance during the energization of the resistive heating element, the upper limit electrical resistance being obtained by adding a predetermined allowable electrical resistance to a predetermined reference electrical resistance.

2. A ceramic heater control apparatus according to claim 1, wherein, at predetermined time intervals after start of energization of the resistive heating element, the control apparatus obtains the electrical resistance of the resistive heating element, determines whether or not the obtained electrical resistance of the resistive heating element asymptotically changes to a predetermined value, sets the reference electrical resistance to be equal to the electrical resistance obtained upon determination that the electrical resistance of the resistive heating element asymptotically changes to the predetermined value, and stops the energization of the resistive heating element when the electrical resistance of the resistive heating element obtained after setting of the reference electrical resistance has exceeded the upper limit electrical resistance.

3. A ceramic heater control apparatus according to claim 2, wherein the control apparatus determines whether or not an increase gradient of the obtained electrical resistance of the resistive heating element is less than a threshold gradient determined beforehand such that, when the electrical resistance of the resistive heating element is highly likely to asymptotically change to the predetermined value, the increase gradient becomes less than the threshold gradient, and sets the reference electrical resistance to be equal to the electrical resistance obtained upon determination that the increase gradient of the electrical resistance of the resistive heating element is less than the threshold gradient.

4. A ceramic heater control apparatus according to claim 2, wherein, when a period of time set beforehand has elapsed after the electrical resistance of the resistive heating element was determined to asymptotically change to the predetermined value, the control apparatus cancels a process of stopping the energization of the resistive heating element upon the determination that the electrical resistance of the resistive heating element exceeds the upper limit electrical resistance.

5. A ceramic heater control apparatus according to claim 2, wherein the allowable electrical resistance is set beforehand as an electrical resistance determined such that, if the energization of the resistive heating element is continued after the electrical resistance of the resistive heating element has exceeded the upper limit electrical resistance, cracking is highly likely to occur in the ceramic heater.

6. A ceramic heater control apparatus according to claim 2, wherein the ceramic heater is a heat exchanger for heating a liquid medium flowing through a flow passage in an apparatus mounted in a vehicle.

7. A heating apparatus comprising:
a ceramic heater including a resistive heating element which generates heat when energized and a ceramic base body in which the resistive heating element is embedded; and
a ceramic heater control apparatus according to claim 1.

8. A non-transitory computer readable recording medium which stores a program to be executed by an ECU provided in a ceramic heater control apparatus which controls a ceramic heater including a resistive heating element which generates heat when energized and a ceramic base body in which the resistive heating element is embedded, the program causing the ECU to perform a step of energizing the resistive heating element and a step of stopping the energization of the resistive heating element when the electrical resistance of the resistive heating element has exceeded an upper limit electrical resistance during the energization of the resistive heating element, the upper limit electrical resistance being obtained by adding a predetermined allowable electrical resistance to a predetermined reference electrical resistance.
